(19) United States
(12) Patent Application Publication
(10) Pub. No.: US 2002/0080531 A1
(43) Pub. Date: Jun. 27, 2002

(54) Electromagnetic linear actuator and tape drive using the same

(75) Inventors: Hiromi Inoguchi, Tokyo (JP); Ikuichiro Nawa, Atsugi-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Mitsumi Electric Co., Ltd., Tokyo (JP)

(21) Appl. No.: 10/027,666

(22) Filed: Dec. 20, 2001

(30) Foreign Application Priority Data
Dec. 25, 2000 (JP) 392018/2000

(51) Int. Cl. G11B 5/55

(52) U.S. Cl. 360/261.1

(57) ABSTRACT

An electromagnetic linear actuator includes an integral formed product produced by integrally forming a plate-like base for mounting a guide and a yoke of a fixed portion. The integral formed product is called a yoke base. The yoke base may be, for example, formed by drawing a plate to serve as the base. It is preferable that the yoke of the fixed portion has a cylindrical portion and an annular upper surface portion arranged at an upper end of the cylindrical portion and having a circular opening formed at its center.

### BACKGROUND OF THE INVENTION

This invention relates to a tape drive for use in a linear tape storage system represented by DLT (Digital Linear Tape) or LTO (Linear Tape Open) and, in particular, to a linear actuator which can be used as a head feed mechanism for moving a magnetic head used in the tape drive.

A linear tape storage system of the type has been developed as a backup for a computer system. A variety of linear tape storage systems have heretofore been proposed. For example, a digital linear tape drive as the DLT is disclosed in U.S. Pat. No. 5,862,014.

The digital linear tape drive is adapted to receive a tape cartridge having a single supply reel. The digital linear tape drive includes a take-up reel in the interior thereof. When the tape cartridge is received in the tape drive, a magnetic tape is pulled out from the tape cartridge to be wound up around the take-up reel through a head guide assembly. The head guide assembly serves to guide to a magnetic head the magnetic tape pulled out from the tape cartridge. The magnetic head exchanges information to and from the tape.

As disclosed in U.S. Pat. No. 5,793,574 for example, a tape drive typically comprises a generally rectangular housing having a common base. The base has two spindle motors. The first spindle motor has a permanently mounted spool permanently mounted to the base to serve as a take-up reel. The spool is dimensioned to accept a magnetic tape streaming at a relatively high speed. The second spindle motor is adapted to receive a removable tape cartridge.

The removable tape cartridge is manually or automatically inserted into the drive via a slot formed on a housing of the drive. When the tape cartridge is inserted into the slot, the cartridge is engaged with the second spindle motor. Prior to rotation of the first and the second spindle motors, the tape cartridge is connected to the permanently mounted spool by means of a mechanical buckling mechanism. A number of guide rollers are positioned between the tape cartridge and the permanently mounted spool and guide the magnetic tape as it streams at a relatively high speed back and forth between the tape cartridge and the permanently mounted spool.

The tape drive further comprises a head assembly. The head assembly is positioned between the spool and the tape cartridge along a tape path defined by a plurality of rollers. During operation of the tape drive, the magnetic tape streams between the spool and the tape cartridge along the tape path, coming into close proximity to the head assembly during streaming. An example of the head assembly is disclosed in U.S. Pat. No. 5,793,574 mentioned above. On the other hand, Japanese Unexamined Patent Publication No. 2000-149491 (JP 2000-149491 A) discloses an example of the tape cartridge to be received in the digital linear tape drive.

In order to move the head assembly up and down in a widthwise direction of the magnetic tape, the tape drive further includes a head feed mechanism. For example, the head feed mechanism comprises a threaded shaft, i.e., a lead screw as disclosed in U.S. Pat. No. 5,793,574 mentioned above. By rotating the lead screw, the head assembly is linearly moved up and down. The head feed mechanism of the type is herein referred to as a “mechanical linear actuator”.

In the mechanical linear actuator, position control of the head assembly is carried out by so-called open-loop control. Therefore, it is difficult to controllably bring the head assembly to a desired position with high accuracy.

In view of the above, the present inventors have proposed a head feed mechanism for moving a head assembly up and down by electromagnetic force. The head feed mechanism of the type will herein be referred to as an “electromagnetic linear actuator”.

In the electromagnetic linear actuator, position control of the head assembly can easily be carried out by closed-loop (feedback) control. It is therefore possible to controllably bring the head assembly to a desired position with high accuracy.

However, the electromagnetic linear actuator may have various problems such as an increase in number of components, an increase in number of assembling steps, and an increase in mounting space.

### SUMMARY OF THE INVENTION

It is therefore an object of this invention to provide an electromagnetic linear actuator which is advantageously reduced in number of components, in number of assembling steps, and in mounting space.

It is another object of this invention to provide a tape drive comprising the above-mentioned electromagnetic linear actuator for moving a magnetic head.

Other object of the present invention will become clear as the description proceeds.

According to the present invention, there is provided an electromagnetic linear actuator which comprises a fixed portion, a movable portion holding an object and movable relative to the fixed portion in upward and down ward directions, a guide coupled to the fixed portion for guiding the movable portion with inhibiting the movement of the movable portion except in the upward and the downward directions, and an electromagnetic device coupled to the fixed portion and the movable portion for generating electromagnetic power acting between the fixed portion and the movable portion. The fixed portion has a base for mounting the guide and a yoke integral with the base for acting as a part of the electromagnetic device.

According to another aspect of this invention, there is provided a tape drive comprising the above-mentioned electromagnetic linear actuator and a head assembly as the object held by the movable portion.

### BRIEF DESCRIPTION OF THE DRAWING

FIG. 1 is a plan view of a tape drive comprising an electromagnetic linear actuator according to a first embodiment of this invention;

FIG. 2 is a partially-sectional perspective view showing the electromagnetic linear actuator in the tape drive illustrated in FIG. 1;

FIG. 3 is an exploded perspective view of the electromagnetic linear actuator illustrated in FIG. 2;

FIG. 4 is a sectional view of the electromagnetic linear actuator illustrated in FIG. 2;

FIG. 5 is a perspective view of a yoke base used in the electromagnetic linear actuator illustrated in FIG. 2;

FIG. 6 is a half-section perspective view of the yoke base illustrated in FIG. 5;

FIG. 7 is an exploded perspective view of an electromagnetic linear actuator according to a second embodiment of this invention; and

FIG. 8 is a sectional view of the electromagnetic linear actuator illustrated in FIG. 7.

### DESCRIPTION OF THE PREFERRED EMBODIMENT

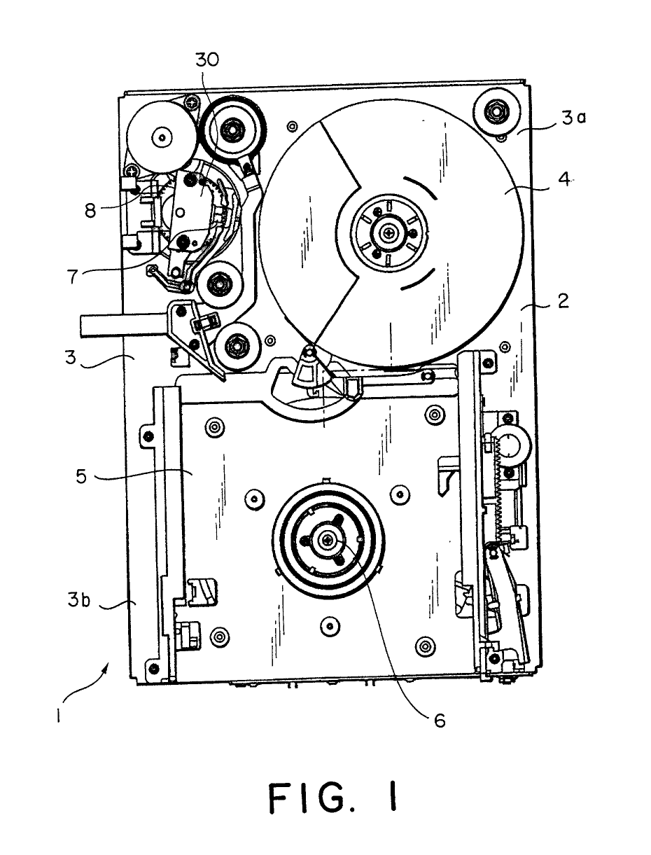

Referring to FIG. 1, description will be made of a tape drive comprising an electromagnetic linear actuator according to a first embodiment of this invention.

The tape drive is depicted by a reference numeral 1 and includes a chassis 2 having an upper surface 3 and a lower surface opposite to the upper surface 3. The chassis 2 comprises a sheet metal chassis made of an iron-based magnetic material. The upper surface 3 is divided into first and second upper regions 3a and 3b. The tape drive further comprises a take-up reel 4 rotatably mounted to the chassis 2 on the first upper region 3a. The take-up reel 4 is driven and rotated by a take-up motor (not shown) attached to the chassis 2 on the lower surface.

A slot portion 5 is formed on the second upper region 3b of the upper surface 3 of the chassis 2. The slot portion 5 is adapted to receive a tape cartridge (not shown) comprising a rotatable supply reel (not shown). In the slot portion 5, a supply rotor 6 to be engaged with the supply reel of the tape cartridge is exposed. The supply rotor 6 is driven and rotated by a supply motor (not shown) attached to the chassis 2 on the lower surface.

The tape drive illustrated in the figure further includes a head assembly 7 having a magnetic head. The head assembly 7 is positioned on a tape path defined by a plurality of rollers. During operation of the tape drive, a magnetic tape streams between the take-up reel 4 and the tape cartridge along the tape path, coming into close proximity to the head assembly 7 during streaming. Thus, information exchange between the magnetic head and the magnetic tape can be carried out.

In order to move the head assembly 7 in a widthwise direction of the magnetic tape, i.e., in a direction perpendicular to a sheet plane of the drawing, the tape drive further includes a head feed mechanism 8 comprising an electromagnetic linear actuator. The head assembly 7 corresponds to an object to be moved up and down.

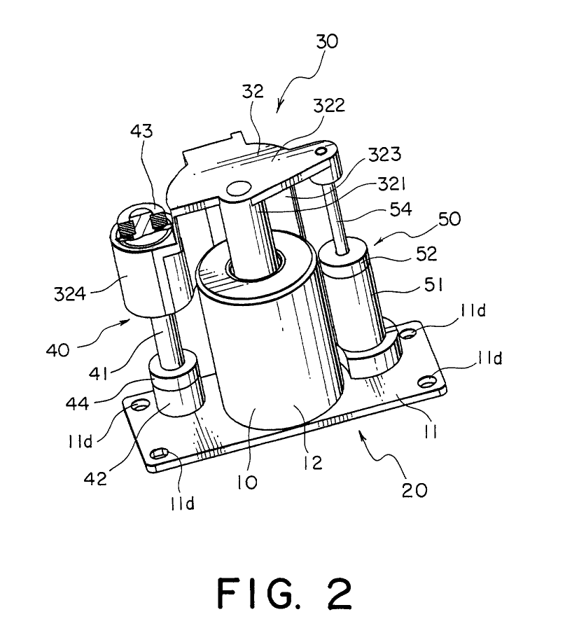

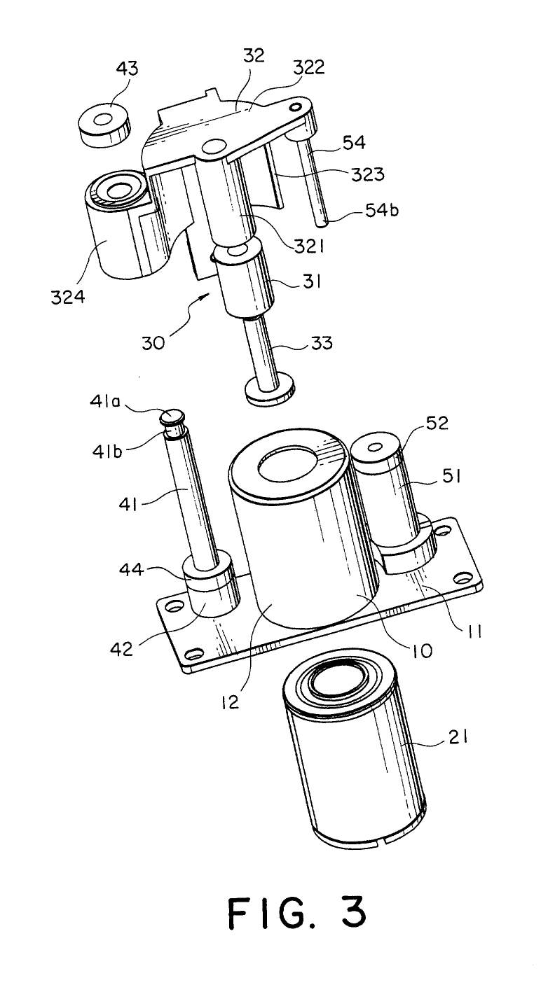

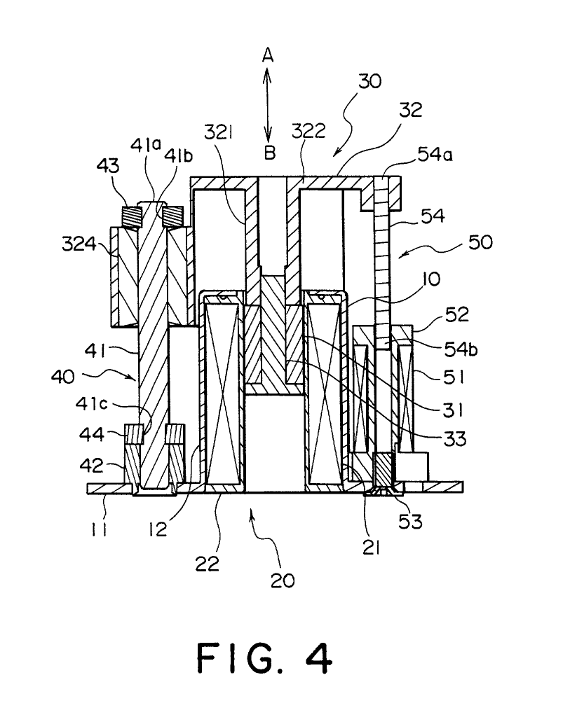

Referring to FIGS. 2 through 4 in addition to FIG. 1, description will be made of the electromagnetic linear actuator.

The electromagnetic linear actuator illustrated in the figure is of a “movable magnet type” and comprises a fixed portion 20, a movable portion 30 holding the head assembly 7 and movable in upward and downward directions A and B with respect to the fixed portion 20, and a guide 40 for guiding the movable portion 30 with inhibiting the movement thereof except up-and-down movement. The fixed portion 20 has a yoke base 10 which comprises a plate-like base 11 and a cylindrical yoke 12 integrally formed. The guide 40 is attached to the base 11. The yoke 12 contains a hollow bobbin 22 with a coil 21 wound therearound.

On the other hand, the movable portion 30 comprises a cylindrical magnet 31 extending in the upward and the downward directions A and B, a bracket 32 mounted on the magnet 31, and a center yoke 33 inserted into the magnet 31 to connect the magnet 31 and the bracket 32. The magnet 31 is received in the bobbin 22 to be slidable in the upward and the downward directions A and B. The magnet 31 has an outer diameter substantially equal to the inner diameter of the bobbin 22. A combination of the yoke 12, the coil 21, the magnet, 31, and the center yoke 33 is referred to as an electromagnetic device which generates electromagnetic power acting between the coil 21 and the magnet 31 when the coil 21 is supplied with an electrical current in the manner known in the art.

The bracket 32 has a cylindrical portion 321 standing on the magnet 31 and extending in the upward direction A, a sector portion 322 disposed at an upper end of the cylindrical portion 321 and extending outward in a radial direction perpendicular to the upward and the downward directions A and B, and a curved portion 323 disposed at an outer peripheral edge of the sector portion 322 and extending in the downward direction B in parallel to the cylindrical portion 321. The head assembly 7 is attached to an outer surface of the curved portion 323.

The guide 40 comprises a guide shaft 41 attached to the base 11 and extending on a guide attaching hole 11b in the upward direction A, and a cylindrical bushing 42 disposed at a lower end of the guide shaft 41 and fitted to the guide attaching hole 11b to thereby attach the guide shaft 41 to the base 11 on the guide attaching hole 11b. A cylindrical bearing 324 protrudes from one lateral end of the curved portion 323 of the bracket 32 outward in the radial direction and is attached to the guide shaft 41 to be slidable in the upward and the downward directions A and B.

The guide shaft 41 has a top end 41a in the upward direction A, a first ring groove 41b formed adjacent to the top end 41a, and a second ring groove 41c formed adjacent to the bushing 42 on an upper side thereof. A first ring damper 43 is fitted to the first ring groove 41b while a second ring damper 44 is fitted to the second ring groove 41c. Therefore, the bearing 324 is slidable between the first and the second ring dampers 43 and 44 along the guide shaft 41 in the upward and the downward directions A and B.

The electromagnetic linear actuator illustrated in the figure further comprises a position sensor 50 for detecting a current position of the movable portion 30 in the upward and the downward directions A and B. The position sensor 50 is attached to the base 11 and extends on a sensor attaching hole 11c in the upward direction A.

More specifically, the position sensor 50 comprises a hollow sensor bobbin 52 with a sensor coil 51 wound therearound, a screw 53 engaged with the sensor bobbin 52 through the sensor attaching hole 11c so that the sensor bobbin 52 is attached to the base 11 to stand on the sensor attaching hole 11 in the upward direction A, and a sensor shaft 54 extending in the upward and the downward directions A and B. The sensor shaft 54 has one end 54a fixed to the sector portion 322 at an upper position corresponding to the sensor attaching hole 11c and the other end 54b inserted into the sensor bobbin 52. The sensor shaft 54 has an outer diameter substantially equal to an inner diameter of the sensor bobbin 52. The position sensor 50 detects the amount or length of insertion of the sensor shaft 54 into the sensor bobbin 52 as the change in inductance value so that the current position of the movable portion 30 with respect to the base 11 (fixed portion 20) is detected as a detected position.

The position sensor 50 produces a position detection signal representative of the current position (detected position) of the movable portion 30 and transmits the position detection signal to a controller (not shown). The controller compares the detected position represented by the position detection signal and a target position of the movable portion 30 and controls the electric current supplied to the coil 21 wound around the bobbin 22 so that the detected position is coincident with the target position. Thus, by the use of the electromagnetic linear actuator, position control of the head assembly (object to be moved up and down) 7 can be carried out by closed loop (feedback) control.

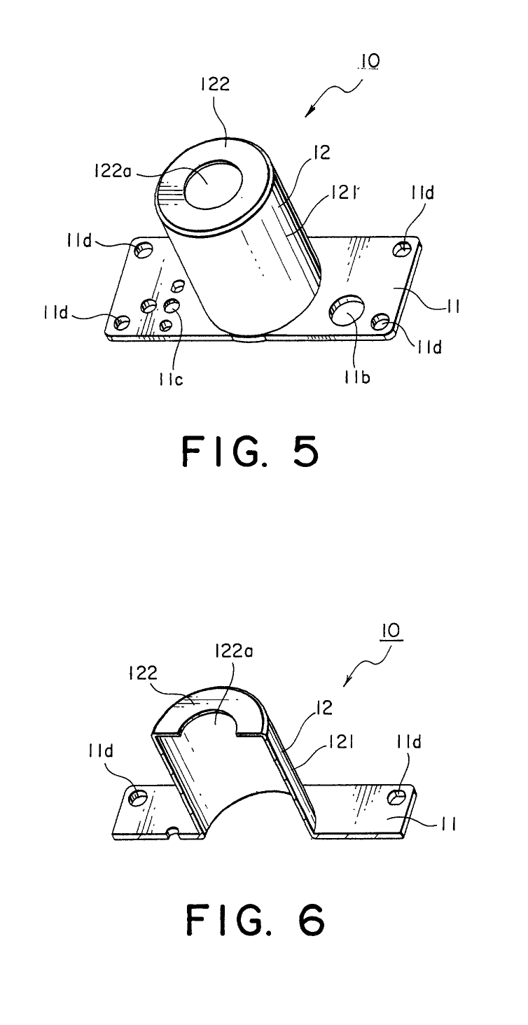

Referring to FIGS. 5 and 6 in addition to FIGS. 1 through 4, the yoke base 10 will be described.

The yoke base 10 illustrated in the figure is an integral formed product produced by partially drawing a plate-like metal material to form the plate-like base 11 and the cylindrical yoke 12 integral with each other. The yoke 12 has a cylindrical portion 121 and an annular upper surface portion 122 arranged at an upper end of the cylindrical portion 121 and having a circular opening 122a formed at its center.

With this structure, the base 11 and the yoke 12 are not separately produced. Accordingly, it is unnecessary to position the yoke 12 with respect to the base 11. Since the yoke 12 is hollow, it is possible to use a space left in a center area of the base 11 at the bottom of the yoke 12. Since the base 11 and the yoke 12 are integrally formed into the yoke base 10 as a single integral component, the number of assembling steps is reduced. Furthermore, any fastening means, such as screws, to attach the yoke 12 to the base 11 are not required so that the number of components is reduced and that it is possible to save a mounting space.

As described above, the base 11 is provided with the guide attaching hole 11b for attaching the guide 40 and the sensor attaching hole 11c for attaching the position sensor 50 for detecting the current position of the movable portion 30 in the upward and the downward directions A and B. The base 11 is further provided with four through holes 11d for insertion of screw components (not shown) to fix the base 11 to the chassis 2 of the tape drive 1.

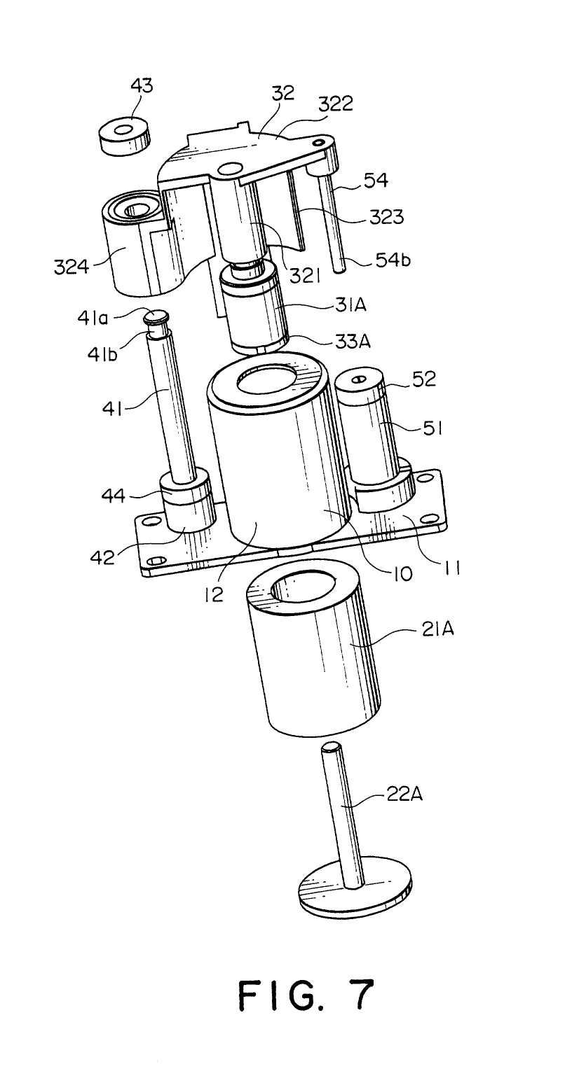

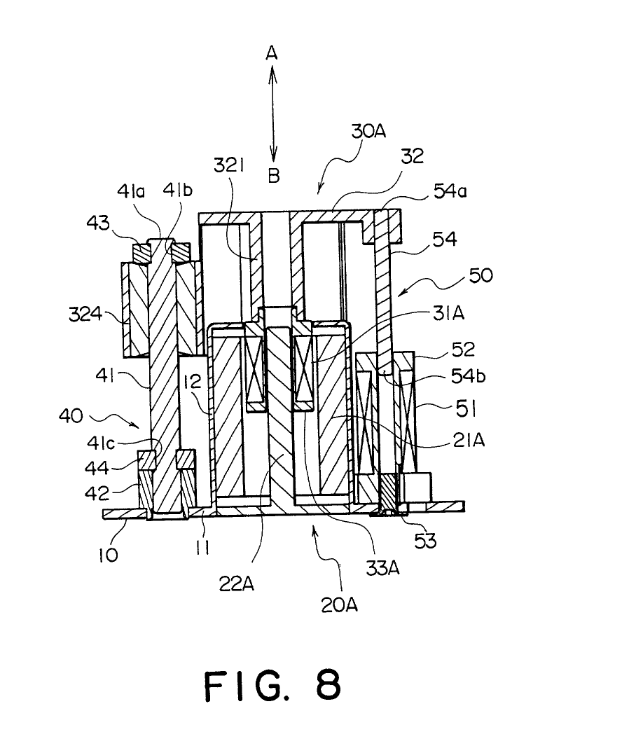

Referring to FIGS. 7 and 8, description will be made of an electromagnetic linear actuator according to a second embodiment of this invention.

The electromagnetic linear actuator illustrated in FIGS. 2 through 4 is of a “movable magnet type” in which the magnet is movable. On the other hand, the electromagnetic linear actuator illustrated in FIGS. 7 and 8 is of a “movable coil type” in which the coil is movable. Thus, the first and the second embodiments are different in structure of the fixed portion and the movable portion. Therefore, the fixed portion and the movable portion in this embodiment are depicted by 20A and 30A, respectively. Those parts identical in function are designated by the same reference numerals and description thereof will be omitted for brevity of description.

The fixed portion 20A comprises a cylindrical magnet 21A received in the yoke 12 of the yoke base 10, and a center yoke 22A fixed at a lower end of the yoke 12 and extending in the upward direction A.

On the other hand, the movable portion 30A includes a hollow bobbin 33A disposed between the magnet 21A and the center yoke 22A and having a coil 31A wound therearound. The bobbin 33A has an upper end connected to a lower end of the cylindrical portion 321 of the bracket 32. The bobbin 33A is slidable in the upward and the downward directions A and B with respect to the center yoke 22A. The bobbin 33A has an inner diameter substantially equal to an outer diameter of the center yoke 22A.

Although this invention has thus far been described in conjunction with the preferred embodiments, it will readily be understood that this invention is not restricted thereto. For example, in the foregoing embodiments, the yoke base 10 corresponding to the base 11 and the yoke 12 is molded as a single integral component. Alternatively, the base 11 and the yoke 12 may be produced as separate components and integrally formed (assembled) without using any fastening parts such as screws. For example, The base 11 and the yoke 12 may be integrally formed (assembled) by caulking or staking, press-fitting, welding or fusing, mechanical-fitting, or sintering. In the foregoing embodiment, description is directed to the case where the object to be moved up and down is the head assembly. However, the object is not restricted thereto at all.

What is claimed is:

1. An electromagnetic linear actuator comprising:
a fixed portion;
a movable portion holding an object and movable relative to said fixed portion in upward and downward directions;
a guide coupled to said fixed portion for guiding said movable portion with inhibiting the movement of said movable portion except in said upward and said downward directions; and
an electromagnetic device coupled to said fixed portion and said movable portion for generating electromagnetic power acting between said fixed portion and said movable portion, said fixed portion having a base for mounting said guide and a yoke integral with said base for acting as a part of said electromagnetic device.

2. The electromagnetic linear actuator according to claim 1, wherein said electromagnetic device comprises:
a bobbin coupled to said yoke;
a coil wound around said bobbin; and
a magnet connected to said movable portion and electromagnetically coupled to said coil.

3. The electromagnetic linear actuator according to claim 1, wherein said electromagnetic device comprises:
a bobbin coupled to said movable portion;
a coil wound around said bobbin; and
a magnet connected to said yoke and electromagnetically coupled to said coil.

4. The electromagnetic linear actuator according to claim 1, wherein said base has a plate-like shape while said yoke has a cylindrical shape.

5. The electromagnetic linear actuator according to claim 4, wherein said base and said yoke are formed as an integral formed product by drawing.

6. The electromagnetic linear actuator according to claim 4, wherein said base and said yoke are coupled to each other by caulking.

7. The electromagnetic linear actuator according to claim 4, wherein said base and said yoke are coupled to each other by press-fitting.

8. The electromagnetic linear actuator according to claim 4, wherein said base and said yoke are coupled to each other by welding.

9. The electromagnetic linear actuator according to claim 4, wherein said base and said yoke are coupled to each other by mechanical-fitting.

10. The electromagnetic linear actuator according to claim 4, wherein said base and said yoke are formed as an integral formed product by sintering.

11. The electromagnetic linear actuator according to claim 1, wherein said object is a head assembly of a tape drive.

12. A tape drive comprising:
an electromagnetic linear actuator according to claim 1; and
a head assembly as said object held by said movable portion.
